(19) United States
(12) Patent Application Publication
(10) Pub. No.: US 2022/0101241 A1
(43) Pub. Date: Mar. 31, 2022

(54) Method for Commercializing and Promoting Talents

(71) Applicant: Lulubite Ltd, Jerusalem (IL)

(72) Inventors: Assaf Bivas, Karkur Pardes Hana (IL); Gil Blumenfeld, Even Yehuda (IL); Dave Wolf, Ramat Bet Shemesh (IL)

(73) Assignee: Lulubite Ltd, Jerusalem (IL)

(21) Appl. No.: 17/548,540

(22) Filed: Dec. 12, 2021

Related U.S. Application Data
(63) Continuation-in-part of application No. 16/858,631, filed on Apr. 26, 2020.

(51) Int. Cl. G06Q 10/06; G06Q 40/04; G06Q 10/10; G06Q 20/12; G06F 16/9535; G06F 16/951

(52) U.S. Cl. CPC G06Q 10/063112; G06Q 40/04; G06Q 10/06398; G06F 16/951; G06Q 20/123; G06F 16/9535; G06Q 10/109

(57) ABSTRACT

The present disclosure, relates to an effective solution for promoting talented individuals (unless stated otherwise an individual may refer to a person and/or a team of people and/or a person with equipment [e.g., a musical instrument]). A system for promoting talented people may include web platform database for gathering, storing, organizing and/or presenting data on talented individuals, their talents and/or evaluations of their talents. In some embodiments, the database is publicized in a way that allows users to find people with talents and a reliable evaluation thereof. Optionally, the system facilitates investing in the talented individual, booking the talented individual and/or searching for talented individual.

### RELATED APPLICATION/S

This application is a Continuation-in-Part of U.S. patent application Ser. No. 16/858,631 filed Apr. 26, 2020, from which this application claims the benefit of priority under, and the contents of which are incorporated herein by reference in their entirety.

### FIELD AND BACKGROUND OF THE INVENTION

The present invention in some embodiments, relates to a system and method for commercializing and promoting talented individuals.

Many talented people in a variety of fields wish to move forward professionally, to gain public and professional exposure, and to enhance their commercial potential.

### SUMMARY OF THE INVENTION

According to an aspect of some embodiments of the invention, there is provided a system for promoting artisans including: collating information on talents of talented individuals; collecting evaluations on a level of the talents; supplying a database including the information on talents facilitating searching for talented individuals; commercializing the talented individuals using the database.

According to some embodiments of the invention, the commercializing includes: facilitating investment of an investor in shares of a specific individual of the talented individuals.

According to some embodiments of the invention, the commercializing includes booking the specific individual.

According to some embodiments of the invention, the commercializing includes selling references and data from the database.

According to some embodiments of the invention, the database includes a plurality of talent cards and wherein each of the talent cards includes at least: a talent profile; one or more evaluations, each of the one or more evaluations including an evaluator score, and optionally one or more purchaser's names and ranks.

According to some embodiments of the invention, the talent profile includes information collected on the talented individual from at least: a questionnaire; one or more professional profiles from one or more professional associations; and one or more internet profiles.

According to some embodiments of the invention, links to samples of work of the talented individual are stored in the database.

According to some embodiments of the invention, the samples of work include at least one of written samples, written testimonials, visual samples, photographs, videos, audio samples, music and voice recordings.

According to some embodiments of the invention, the evaluations include at least one evaluation by an evaluator who is a talented individual in a field in which the talented individual is being evaluated.

According to some embodiments of the invention, the evaluator is a talented individual who has talent card in the database.

According to some embodiments of the invention, the evaluator is encouraged to evaluate the talented individual in exchange for one or more benefits.

According to some embodiments of the invention, the one or more benefits include monetary payment, in order to remain listed in the database or to get points added to their evaluator score.

According to some embodiments of the invention, the evaluator score is at least derived from at least one of: knowledge of the evaluator in a field of the talented individual; review of at least one of the talent profile a work samples provided by the database; and a questionnaire.

According to some embodiments of the invention, a score provided by the evaluator is reviewed prior to addition to the database.

According to some embodiments of the invention, a score provided by the evaluator is a combined score determined by combining multiple individual evaluator scores.

According to some embodiments of the invention, the investing is in a plurality of talent cards.

According to some embodiments of the invention, the investing in bulk includes investing in at least one talent card in part.

According to some embodiments of the invention, the investor provides at least one of employment, sponsorships and donations to the specific individual based on their talent card.

According to some embodiments of the invention, information on the investor is stored in the database.

According to some embodiments of the invention, the information on the investor is added to the talent card purchased.

According to some embodiments of the invention, the investor is ranked according to at least one of a number of talent cards purchased and the employment, sponsorships and/or donations are provided to one or more talented individuals.

According to an aspect of some embodiments of the invention, there is provided a method for promoting artisans including: collating information on talents of talented individuals; collecting evaluations on a level of the talents; supplying a database including the information on talents facilitating searching for talented individuals; and commercializing the talented individuals using the database.

According to some embodiments of the invention, the commercializing includes: facilitating investment of an investor in shares of a specific individual of the talented individuals.

According to some embodiments of the invention, the commercializing includes booking the specific individual.

According to some embodiments of the invention, the commercializing includes selling references and data from the database.

According to some embodiments of the invention, the method further includes storing the information on talents on talent cards stored in a database.

According to some embodiments of the invention, the method further includes selling access to data from the database on payment of a fee.

According to some embodiments of the invention, the method further includes: creating talent profiles of the talented individuals; and examining a profile of at least one of the talented individuals and providing an evaluator score.

According to some embodiments of the invention, the evaluator score is derived from at least: knowledge of an evaluator in a field of the talented individual; review of a talented individuals talent profile and/or work samples provided by the database; and a questionnaire.

According to some embodiments of the invention, the method further includes computing an evaluator score by combining multiple individual evaluator scores.

According to some embodiments of the invention, at least one of the evaluated scores in is supplied by an evaluator who is a talented individual in a field being evaluated.

According to some embodiments of the invention, the evaluator has talent card in the database.

According to some embodiments of the invention, the method further includes encouraging the evaluator to evaluate the talented individual in exchange for one or more benefits.

According to some embodiments of the invention, the method further includes commercializing a talent card in part.

According to some embodiments of the invention, the commercializing includes an investor providing at least one of employment, sponsorships and donations to a talented person based on their talent card.

According to some embodiments of the invention, the method further includes storing information on an investor in the database.

According to some embodiments of the invention, the method further includes ranking the investor in the database based on at least one of a number of talent cards purchased, the employment, sponsorships and/or donations the investor provides to one or more talented individuals.

According to some embodiments of the invention, the method further includes valueing a talent card according to at least one of: a talent profile of the talented individual; a score provided by the evaluator; and a rank of the investor.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) and/or a mesh network (meshnet, emesh) and/or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

Data and/or program code may be accessed and/or shared over a network, for example the Internet. For example, data may be shared and/or accessed using a social network. A processor may include remote processing capabilities for example available over a network (e.g., the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a block diagram of a system for talent publicizing in accordance with an embodiment of the current invention;

FIG. 1B is a flow chart illustrating a method of registering a talented person in accordance with an embodiment of the current invention;

FIG. 1C is a flow chart illustrating a method of registering an evaluator in accordance with an embodiment of the current invention;

FIG. 2 is a block diagram of a system for talent publicizing in accordance with an embodiment of the current invention;

FIG. 3 is a diagram illustrating an embodiment of the invention;

FIG. 4 is a flow diagram illustrating an embodiment of the invention;

FIG. 5 is a flow diagram illustrating a talent profile according to an embodiment of the invention;

FIG. 6 is a diagram illustrating a talent profile according to an embodiment of the invention;

FIG. 7 is a diagram illustrating an evaluator score according to an embodiment of the invention; and

FIG. 8 is a diagram illustrating a talent card according to an embodiment of the invention.

### DESCRIPTION OF SEVERAL EMBODIMENTS OF THE INVENTION

The present invention, in some embodiments thereof, in some embodiments thereof, relates to a system and method for commercializing and promoting talents, and optionally, in the form of an internet database.

### Overview

According to an aspect of some embodiments of the present invention there is provided a system and/or method for promoting artisans comprising:

collating information on talents of talented individuals

collecting evaluations on a level of said talents

supplying a database including said information on talents facilitating searching for talented individuals

selling references and data from said database in the form of one or more talent cards.

According to some embodiments of the invention, a talent card may comprise at least a talent profile and an evaluator score.

The present invention, in some embodiments thereof, relates to an effective solution for promoting talented individuals (unless stated otherwise an individual may refer to a person and/or a team of people and/or a person with equipment [e.g., a musical instrument]) by providing a method that is a web platform database for gathering, storing, organizing and/or presenting data on talented individuals, their talents and/or evaluations of their talents. In some embodiments, the database is publicized in a way that allows users to find people with talents and a reliable evaluation thereof.

People who need skilled artisans do not have a reliable way to find and evaluate an artisan. They therefore are forced to rely on informal networks such as word of mouth or social media.

New artisans have difficulty being recognized and cannot get a break except through connections in the field. This can present a bias towards privileged groups who have access to more formal qualifications (e.g., formal education, connections etc.).

While artisans may advertise their talents, not all artisans can afford the cost of advertising. Additionally, it may be difficult an advertisement to give a reliable way to judge whether the artisan is really as good as claimed.

User reviews for example on social media or other internet platforms may be helpful but user reviews are not necessarily accurate since the reviewers may not be experts in the field, very few users respond, the responding users may be biased (e.g., friends or family of the artisan and/or competitors) and/or provide biased reviews and/or there may be inadequate objective testing of their accuracy.

In some embodiments an independent database containing artisan profiles includes objective evaluations of the artisans. Optionally, the database is regularly updated and/or checked for accuracy. Optionally, an interface is supplied for easy to access by the artisan, the evaluator, and/or a user interested in the artisans' skills or talents.

### Exemplary Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways. Explanations of possible mechanisms of effect are not intended to limit the invention to a particular theoretical framework.

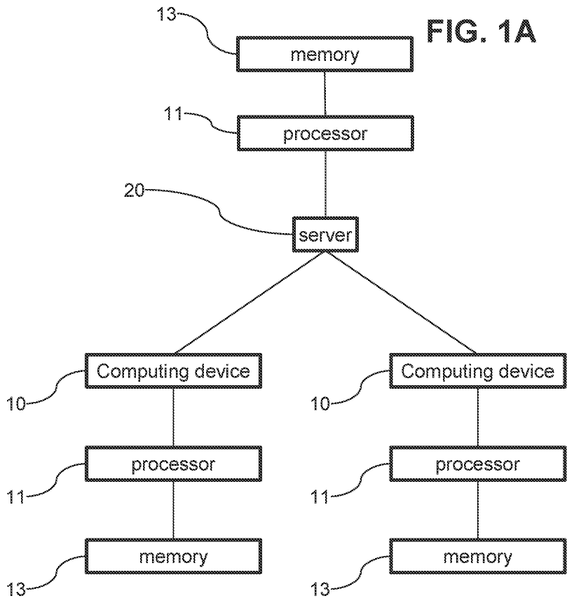

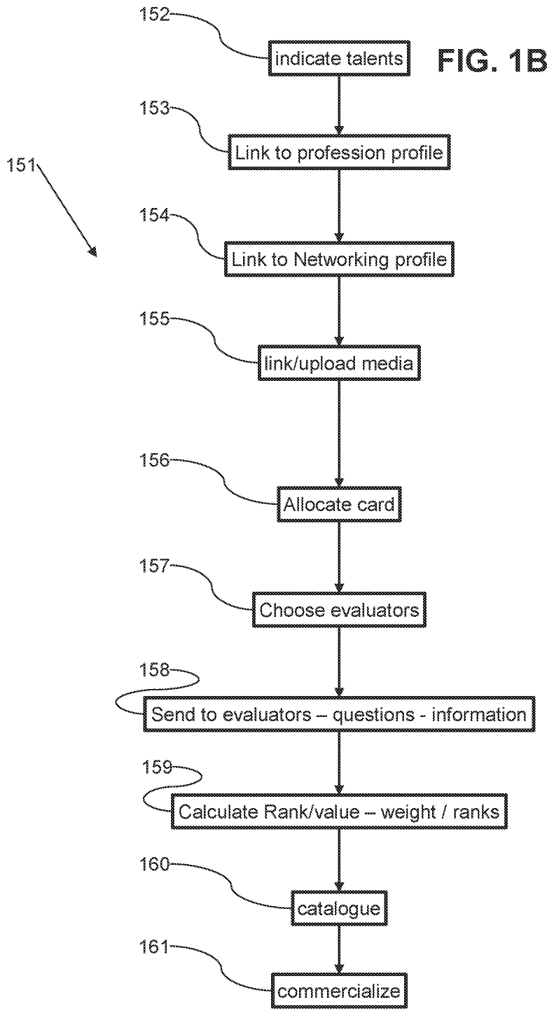

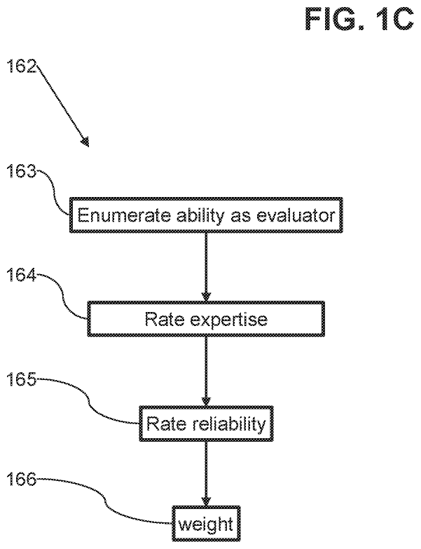

FIG. 1A is a block diagram of a system for talent publicizing in accordance with an embodiment of the current invention. FIG. 1B is a flow chart illustrating a method of registering a talented person in accordance with an embodiment of the current invention. Registration 151 may include any, some or all of the steps depicted in the flow chart. FIG. 1C is a flow chart illustrating a method of registering an evaluator in accordance with an embodiment of the current invention. Registration 162 may include any, some or all of the steps depicted in the flow chart. In some embodiments, a method of promoting talented individuals is performed by a processor 11, in a remote server 20) and in computing devices 10. The term “computing device” 10 hereinafter and in the claims refers to any kind of device which is designed to have network connection (e.g., WIFI, Internet), such as smartphones, computers, tablets and the like.

A web platform such as a computer program or a mobile application may be used as a framework for the overall operation and use of the method and for the sake of fluency, we will use the terms “web platform” and “method” hereinafter in this connection and as having in general the same meaning. A user of a computing device 10 may download the web platform. The web platform may be stored in a memory 13 and/or performed by a processor 11 of the computing device 10, and may be also performed by a processor 11 in a remote server 20.

In some embodiments, a method is designed specifically for commercializing and promoting talented people in a variety of fields. Optionally a web platform enables a user of a computing device 10 to open through his or her computing device 10 a professional account and to register as a talented individual. The talent of the individual can be of a variety of fields, such as, sports, football, basketball, swimming, cycling, art, singing, playing a musical instrument, dancing, painting, and so on.

In some embodiments, the web platform also enables a user of a computing device 10 to register 162 himself or herself through the computing device as an expert evaluator in a specific talent field. Users that register themselves as expert evaluators are usually users with knowledge in the specific talent fields in which they registered. It is not necessary that the expert evaluators should be professional, but it is enough that they have the knowledge and ability to rank and to give a professional opinion on talented users who register as talented users. Alternatively or additionally, an individual may be registered as both an evaluator and/or a talented individual. For example, an evaluator may further register 151 as a talented individual and/or a talented individual may register 162 as an evaluator and/or a person may register 151, 162 for both talent and ranking. In some embodiments, expertise in ranking may be considered on a talent card and/or ranking. Alternatively or additionally, a talent may affect a weight of an evaluator.

In some embodiments, the web platform sends from the remote server 20 to the computing device 10 of a person registering 151 as a talented individual a first computerized form and presents to the talented individual a space to indicate 152 in the computerized form his or her talent field. In some embodiments, the indication may be required for registration 151. For example, the talented individual may choose the talent field from two or more possible talent fields. It is possible and desirable that the web platform should include a variety of primary and sub-categories of talent areas from which the user should specify the talent he or she has.

Optionally, the web platform sends from the server 20 to the computing device 10 a second computerized form and presenting to the talented individual an additional space to type an access link 153 to his or her professional official profile in an official database. In some embodiments, supplying the professional link 153 may be required for registration 151. For example, a professional link may include a business connection where the individual practices his talent and/or a membership in a professional organization. Optionally, the web platform automatically accesses by the remote server through the network to the professional official profile of the talented individual in the official database according to the access link that the talented individual provides. In some embodiments, if the link is not active and/or a valid professional link, the individual will be classified as a non-professional and/or classified as an amateur and/or required to supply more evidence of his professional status and/or disincluded from the database. This step, optionally, filters people who are talented but without a minimal professional background. For example, there may be an indicator and/or database that is exclusively for people that are engage seriously with their talents. Such a professional will optionally create a professional account. For example, a sportsman can provide a link 153 to his professional official profile in the sport association of which he is a member; an artist can provide a link 153 to his professional official profile in the artists association of which he is a member, and so forth. In some cases, the person with a talent who has a professional profile in a professional or semi-professional association may have the minimal level to start commercializing his potential. Optionally, the web platform automatically downloads professional information from the professional official profile of the talented individual and/or uploads this professional information to the professional account of the user.

In some embodiments, the web platform sends from the remote server to the computing device 10 of the talented individual a further computerized form and/or presents to the talented individual a space to type an access link 154 to his or her Internet profile and/or a profile on a social networking platform, such as his or her profiles in Linkedln™, Facebook™, Instagram™, YouTube™ and the like. In some embodiments, the media link may be required for registration. Optionally, the web platform automatically accesses by the remote server 20 and/or through the Internet to the profiles of the talented individual and/or automatically downloads personal information from the Internet profiles and/or uploads this personal information to the professional account of the talented individual. Personal information may include pictures, videos, texts and the like can be used to evaluate the level of the talented individual.

In some embodiments, the web platform sends from the server to the computing device a link to the talented individual to upload 155 to his or her professional account media content (videos, photos, texts) and/or enables the talented individual to upload 155 the media content to his or her professional account and/or provide a link to the media content. The media content can give better information and details about the qualities and abilities of the user in his field of talent, which may be used to assess his level and his commercial potential. In some embodiments, uploading 155 media or a link may be required for registration 151.

In some embodiments, the web platform allocates 156 a talent card to the talented individual. The meaning of the term “talent card” is similar this term when used regarding athletes and players for examples who have a player card that can belong to the teams in which they can commercialize 161 a player. For example, the card can be booked to a talent consumer. For example, the booking may be for a period of time (e.g., the talented individual may be booked for a performance and/or assigned to a team with a contract for performance and/or practice for a year) and/or sold (e.g., investors will get dividends of the renting of the card). Optionally, a commercial potential is affixed to the talented individual through a “talent card” and/or the talented individual and/or an may sell part (e.g., a percent of this talent card, use of the talent [e.g., a performance] at a certain time) to an individual, an organization and/or to the public. Optionally, the purchased parts are negotiable, so the buyer can later sell the part he bought to someone else.

In some embodiments, the web platform automatically chooses 157 evaluators from registered 162 evaluators in the talent field of the user. Optionally, there is a random element in the choice of evaluators. In some embodiments, the web platform may include a big number of expert evaluators in one or more talent fields. For example, the web server may send 158 information on the talented individual to hundreds of even thousands of expert evaluators. The large number of evaluators may facilitate getting clear and/or accurate answers as to the level and qualities of the talented individual in question. Optionally, the web platform automatically generates predetermined number of random numbers and/or associates the random numbers with the corresponding evaluators from the registered 162 evaluators in the talent field of the user that are stored in the memory of the processor in the server. For example, an evaluator may be enumerated 163 and/or rated 164 as an expert for one or more talent categories. For example, the evaluators may be rated 165 according to their reliability (e.g., trustworthiness). Optionally, the evaluators associated with generated numbers are appointed to provide answers as to the qualities of the talented individual. In some embodiments, the web platform automatically sends 158 from the remote server 20 to other computing devices 10 of the appointed evaluators the personal information and the media content of the user. For example, addresses for computing devices 10 of the evaluators may be stored in the memory of the processor in the server the professional information. The web platform optionally sends 158 from the server 20 to the computing devices of the appointed evaluators a questionnaire that includes scaling questions (for example three or more scaling questions) as to the professional qualities of the talented individual to be answered on the scale of a given range of values.

In some embodiments, the web platform receives from the computing devices of the appointed evaluators scaling answers to the questionnaire and/or stores the scaled answers in the processor 11 and/or memory 13 of the server 20. In some embodiments, the web platform may calculate 159 (e.g., by implementing a statistical function stored in the memory and/or performed by the processor 11 of the server 20) a personal score for the talented individual. For example, the score may be calculated 159 based on the received scaling answers. Optionally, the answers may be weighted 166 according to a specific weight of each evaluator. For example, an evaluator may have a weight for ranking a specific talent. The weight may be based on the evaluators ranking in that talent and/or on past performance in ranking and/or on an evaluation of his ranking skill and/or reliability and/or on his history. The weight of the evaluator may be stored in the memory 13 of the processor 11 of the server. The term “scaling questions” means ranking questions that they present an option for respondents to rank the available answers to the questions on the scale of given range of values (for example from 1 to 10). Optionally, using scaling questions, the web platform automatically analyzes the answers and automatically calculate a rank based on the answers from any number of evaluators.

In some embodiments, the web platform calculates 159 a commercial market value of the talent card of the talented individual based on his or her personal score, the professional information, a number of followers of the internet profiles of the talented user, the media content and/or on his or her field of talent. The commercial market value of the talent card is optionally presented in the talent card and/or the professional account of the talented individual. Optionally, any, some or all of the above factors and/or the final market value is calculated 159 by implementing a computer function stored in memory 13 and/or implemented on the processor 11 of the server 20.

In some embodiments, the web server classifies and/or catalogues 160 the cards making them easier to find and/or publicize and/or commercialize 161.

The web platform enables viewers to purchase the talent card or part of it. Then the web platform stores in the processor in the server details of the purchaser that includes his or her share. In response to such purchase the web platform to lists automatically in the professional account the details of the purchaser that are stored in the processor in the server. The web platform may also include a system for selling and buying these shares, similar in a way to stock exchange. In some embodiments, the web platform supplies instructions for various user interfaces to facilitate registration 151, 162, searching for talented individuals, commercializing 161 and/or publicizing a talented user. For example, the web platform enables viewers to order sponsorship services from the talented individual, and enables viewers to donate money or goods to the user.

In an embodiment, a system and/or method may be used for commercializing 161 and promoting talented individuals.

In an embodiment the system and/or method may be in the form of an internet database.

In an embodiment, the database may be searchable for example by keyword, such as by field of talent, number of years of experience, professional association, style, number of previous purchases, reviews, etc.

In an embodiment, the internet database may contain information from artisans, evaluators and/or purchasers.

In an embodiment, artisans or talented individuals may be people with a high degree of skill in a field. Optionally, a variety of fields, such as, sports for example football, basketball, swimming, cycling, etc., art for example, painting, drawing, sculpting, animating, etc., singing, playing one or more musical instruments, dancing for example ballet, hip hop, modern, etc., choreographing, teaching or training in an artistic or sporting field, and so on.

In an embodiment, an evaluator may be a person with knowledge and/or experience in the field of the talented individual. Optionally, the evaluator may be registered as a talented individual in the database. Optionally, the evaluator may be incentivized to provide an evaluation. Optionally, the incentive may be one or more of a benefit such as payment, continued usage of the database, free listing in the database, addition of points added to their evaluator score. Optionally, a link to their evaluations may be added to an evaluator's talent card. Optionally, the evaluations may be used to highlight the evaluator's own skill, knowledge and/or talent in the field. Optionally, the evaluator may provide an evaluation score and/or a written evaluation. Optionally, an evaluation may be reviewed prior to posting and/or addition to a talent card.

In an embodiment, a purchaser may be a user of the database who is interested one or more of an artisans' skills or talents. Optionally, a purchaser may purchase information on one or more talented individuals. Optionally, the purchaser may provide employment, sponsorships and/or donations to one or more talented individuals e.g., talent agent, employer, advertising agency, promotor, etc. Optionally the purchaser's information may be stored in the database. Optionally, the purchaser's information or rank may be added to a talented individual's talent card. Optionally, a potential purchaser may review the purchase history of a talent card and/or a review of the talented individual by a previous purchaser.

In an embodiment, both purchasers and evaluator's may see and/or hear and/or read the work samples and report when a talented individual may be plagiarizing and/or presenting work that may not be their own.

In an embodiment, the database may consist of a number of talent cards. Each talent card may include information provided by the talented individual on their expertise and/or experience (self-reported) and one or more evaluations from an evaluator with professional knowledge in the field.

In an embodiment, a talent card may include with information from one or more professional association profiles, one or more internet profiles, and/or work samples.

In an embodiment, a talented individual may provide a link to one or more professional official profiles from which data may be acquired, either manually or automatically.

In an embodiment, information from a professional or semi-professional association may be used to filter out people who are talented but do not have a minimal professional background or experience, or who do not engage seriously with their talent profiles.

For example, a sportsperson may provide a link to their professional official profile in the sport association of which they are a member; an artist may provide a link to their professional official profile in the artists association of which they are a member, and so forth. It is assumed that any person with a talent who has a professional profile in a professional or semi-professional association may have the minimal level to start commercializing their potential.

In an embodiment, an internet profile may be a talented individual's social media or other internet account such as one or more profiles in Linkedln™, Facebook™, Instagram™, YouTube™, Twitter™, and the like.

Optionally, media content (videos, photos, texts) may be uploaded manually and/or automatically to their talent profile. The media content may give better information and details about the qualities and abilities of the talented individual in their field of talent, which may be used to assess their level of talent and commercial potential.

In an embodiment, work samples may be audio and/or video and/or written. For example, photographs, videos, written texts, spoken word recordings, music or voice recordings. Optionally, certificates and/or accreditations from academic or professional institutions and/or news articles and/or professional reviews may be included in a talent profile. Optionally, the work samples of the talented individuals work may be provided by the talented individual and may be stored in the database for evaluation by an evaluator or a purchaser.

In an embodiment, the system or/and method for promoting artisans may comprise collating information on talents of talented individuals, collecting evaluations on a level of said talents, supplying a database including said information on talents facilitating searching for talented individuals and/or selling references and data from said database in the form of one or more talent cards.

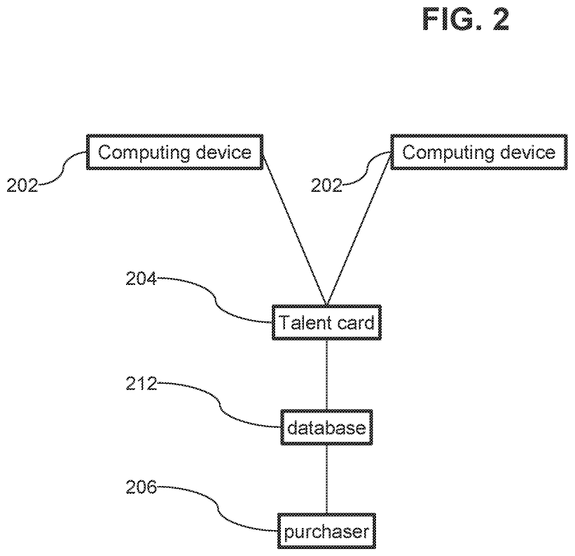

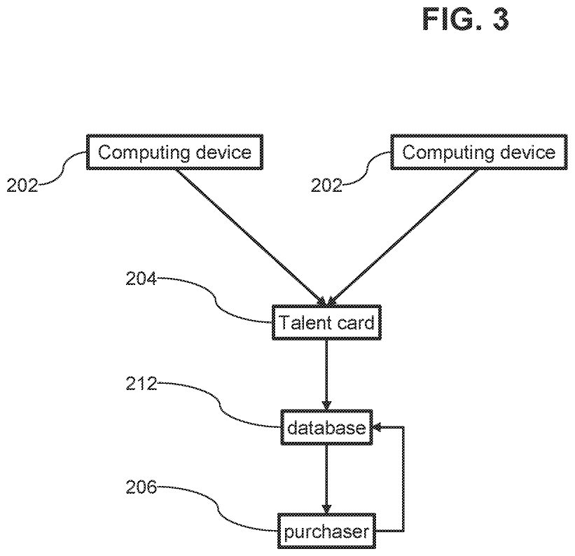

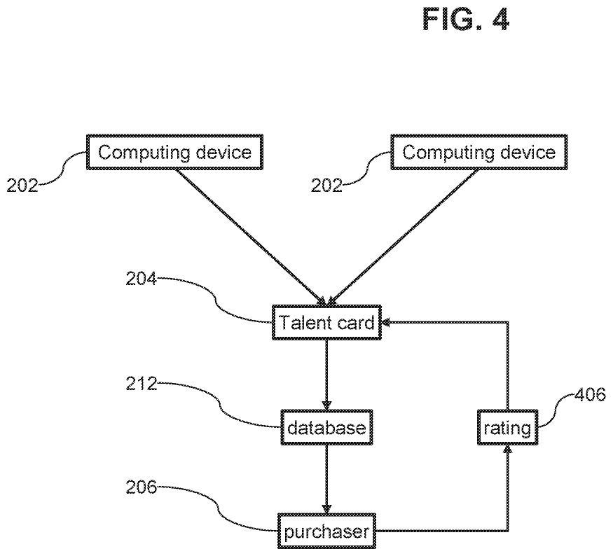

FIG. 2 is a block diagram of a system for talent publicizing in accordance with an embodiment of the current invention. FIGS. 3 and 4 are diagrams illustrating embodiments of the invention. For example, a system may receive data from computing devices 202. For example, the data may be supplied by the talented individual (e.g., during registration) and/or an evaluator (e.g., during evaluation) and/or by a client (e.g., a user review) and/or from another database (e.g., a professional network and/or an Internet site). The data may be built into one or more talent cards 204. Optionally, the data and/or cards are stored and/or organized into a database 212 which may be stored on a memory. Optionally, searching and/or data from the database 212 may be supplied to a purchaser 206. In some embodiments, the purchaser 206 may further send data to the database, for example, buying, renting, investing in, or rating 406 a talent user may be registered into the database 212 (e.g., as illustrated in FIG. 3) and/or the talent card 204 (e.g., as illustrated in FIG. 4).

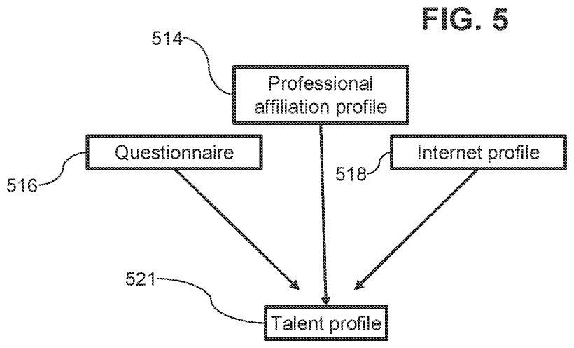

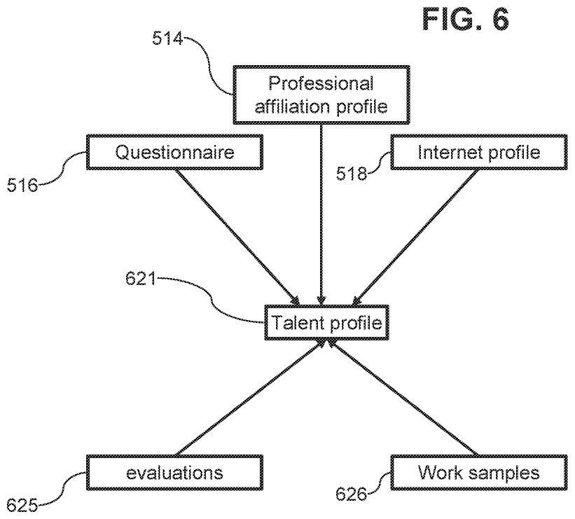

FIGS. 5 and 6 are diagrams illustrating talent profiles 521 according to embodiments of the invention. For example, the talent profile 521 may be included in a talent card.

In an embodiment, the talent card may comprise:
a) A talent profile 521; and/or
b) One or more purchaser's names and ranks an availability for purchase or use of the talent. Additionally or alternatively, the talent profile 621 may include work samples, additional evaluator scores, evaluator reviews, purchaser reviews, written testimonials, information updates, etc.

In an embodiment, a talent profile 521 may comprise information collected on a talented individual from at least:
a) Answers to a questionnaire 516;
b) One or more professional profiles 514 from one or more professional associations; and/or
c) One or more social media and/or Internet profiles 518.

Optionally, the talent profile may include work samples 626, and/or evaluations 625 for example, evaluator scores, evaluator reviews, purchaser reviews, written testimonials, information updates, etc.

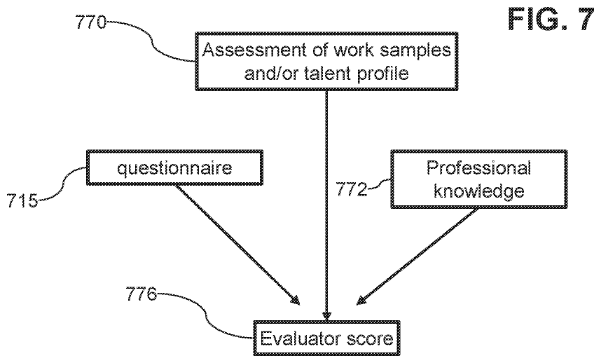

FIG. 7 is a diagram illustrating an evaluator score according to an embodiment of the invention; and

In an embodiment, an evaluator score 776 may be derived from for example:
a) The evaluator's knowledge 772 and/or experience in the field of the talented individual;
b) Assessment 770 of a talented individuals talent profile and/or work samples provided by the database; and/or
c) A questionnaire 715 filled out by the evaluator.

In an embodiment, the evaluator may be a talented individual in the field of the talented individual being evaluated. Optionally, the evaluator may be a talented individual who may be registered and/or has talent card in the database. Optionally, an evaluator may be ranked according to the number of evaluations they provide and/or on the number of times their evaluation leads to purchase of a talent card or employment and/or sponsorship of a talented individual.

Alternatively, and/or additionally, the evaluator may be encouraged to evaluate said talented individual in exchange for one or more benefits. Optionally, the benefits may include monetary payment, may allow continued listed in the database and/or added to the evaluator's rank or their own evaluator score, and/or increase the value of their talent card. Optionally, the evaluator score may be reviewed prior to acceptance and/or addition to the talented individual's talent card. Optionally, links to an evaluator's evaluation may be added to their talent card.

In some embodiments, the reliability of an evaluator may be assessed. For example, the ranks given by the evaluator for talented individuals may be rated for agreement with other evaluators. For example, the ranks given by the evaluator for talented individuals may be rated for agreement with user reviews. For example, the ranks given by the evaluator for talented individuals may be rated according to the number of evaluations in which he has participated and/or the amount time he has been an evaluator. For example, the evaluator may be evaluated by other evaluators.

In an embodiment, the evaluator score may be a combined score determined by combining multiple individual evaluator scores. Optionally, a talent card may be weighted and/or recommended and/or ranked in the database and/or in a result set from a search according to the evaluation score.

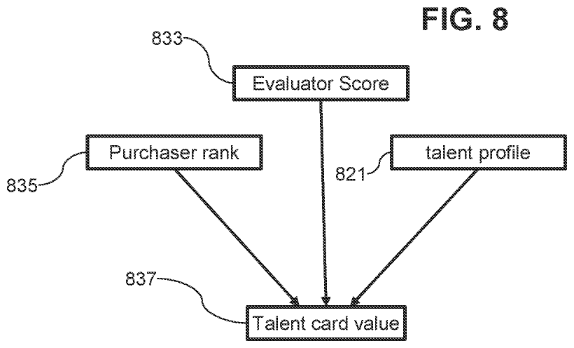

FIG. 8 is a diagram illustrating a talent card according to an embodiment of the invention. In an embodiment, a talent cards may be sold in bulk, individually, in full or in part. Optionally, membership of the database may be sold with limited or unlimited access to the talent cards.

In an embodiment, the purchaser of one or more talent cards may provide employment, sponsorships and/or donations to a talented individual based on their talent card.

In an embodiment, the purchaser's information may be stored in the database and may be added to the talent card purchased. Optionally, the purchaser may be ranked according to the number of talent cards purchased and/or the employment, sponsorships and/or donations are provided to one or more talented individuals.

In an embodiment, various types of users may use the database, for example:
a) Talented individuals, who create talent profiles;
b) Evaluators, who examine a talented individual's profile and provide an evaluator score; and
c) Purchasers, who purchase access to the database and/or one or more talent cards.

In an embodiment, the purchaser may be ranked in the database based on the number of talent cards purchased and/or the employment, sponsorships and/or donations the purchaser provides to one or more talented individuals.

In an embodiment, a purchaser rank may be added to the talent card of the individual whose card was purchased. Optionally, the number and rank or purchasers may influence the value of the talent card. Optionally, a talent card may be recommended or ranked in the database and/or in a result set from a search according to the purchaser rank. Optionally a purchaser score may be included in the talent card. Optionally, the purchaser score may correspond to the purchaser rank. Optionally, the purchaser score may be a combined score from multiple purchasers. Optionally, the purchaser score may be derived from a feedback questionnaire after purchase of a talent card and/or employment or sponsorship of a talented individual. Optionally, the purchaser score and/or evaluation and/or review may be reviewed prior to acceptance and/or addition to the talented individual's talent card.

In an embodiment, the cost of a talent card may be based on a value. In an embodiment, a talent cards may be valued 837 at least according to:
a) The talent profile 821;
b) The evaluator score 833; and optionally
c) The purchaser's rank of the talented individual 835.

Optionally, the number of purchases, work samples, professional associations, internet profiles, positive reviews, evaluation scores, may influence the value of a talent card.

For example, a talented individual may create a talent profile by answering questions in an online questionnaire, providing one or more links to one or more professional associations, providing links to one or more Internet profiles, and uploading work samples. The talent profile is then passed onto an evaluator in the talented individual's field. The evaluator then views/hears/reads the work samples, views the answers to the questionnaire and the information from the professional associations and internet profiles. The evaluator then provides an evaluator score, answers an online questionnaire and/or provides a written evaluation which is reviewed and then added to the talented individual's talent card in the database. A purchaser then searches the database for a talent individual based on selected keywords or field. The database then provides a several talent cards for review by the purchaser. Based on the information in the talent card and/or work samples of the talented individual, the purchaser selects a suitable talented individual to offer employment, sponsorship and/or promotion. The purchaser's information is then added to the selected talented individual's talent card and may provide a review of the talented individual thereafter based on verified employment, sponsorship, or other contact with the talented individual.

General

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for promoting artisans comprising:
collating information on talents of talented individuals;
collecting evaluations on a level of said talents;
supplying a database including said information on talents facilitating searching for talented individuals;
commercializing the talented individuals using the database.

2. The system of claim 1, wherein said commercializing includes:
facilitating investment of an investor in shares of a specific individual of said talented individuals.

3. The system of claim 2, wherein said commercializing includes booking said specific individual, or includes selling references and data from said database.

4. The system of claim 1, wherein said database includes a plurality of talent cards and wherein each of said talent cards comprises at least:
a talent profile;
one or more evaluations, each of said one or more evaluations including an evaluator score, and optionally
one or more purchaser's names and ranks.
wherein the talent profile comprises information collected on the talented individual from at least:
a questionnaire;
one or more professional profiles from one or more professional associations; and
one or more internet profiles;
wherein the evaluator score is at least derived from at least one of:
knowledge of the evaluator in a field of the talented individual;
review of at least one of said talent profile a work samples provided by the database; and
a questionnaire.

5. The system of claim 4, wherein links to samples of work of the talented individual are stored in the database, and wherein said samples of work include at least one of written samples, written testimonials, visual samples, photographs, videos, audio samples, music and voice recordings.

6. The system of claim 1, wherein the evaluations include at least one evaluation by an evaluator who is a talented individual in a field in which said talented individual is being evaluated; wherein the evaluator is a talented individual who has talent card in the database; wherein the evaluator is encouraged to evaluate said talented individual in exchange for one or more benefits; and wherein the one or more benefits include monetary payment, in order to remain listed in the database or to get points added to their evaluator score.

7. The system of claim 6, wherein a score provided by the evaluator is a combined score determined by combining multiple individual evaluator scores.

8. The system of claim 2, wherein said investing is in a plurality of talent cards.

9. The system of claim 8, wherein said investing in bulk includes investing in at least one talent card in part.

10. The system of claim 2, wherein the investor provides at least one of employment, sponsorships and donations to said specific individual based on their talent card; wherein information on the investor is stored in the database; wherein the information on the investor is added to the talent card purchased; and wherein the investor is ranked according to at least one of a number of talent cards purchased and the employment, sponsorships and/or donations are provided to one or more talented individuals.

11. A method for promoting artisans comprising:
collating information on talents of talented individuals;
collecting evaluations on a level of said talents;
supplying a database including said information on talents facilitating searching for talented individuals; and
commercializing the talented individuals using the database.

12. The method of claim 11, wherein said commercializing includes:
facilitating investment of an investor in shares of a specific individual of said talented individuals.

13. The method of claim 12, wherein said commercializing includes booking said specific individual.

14. The method of claim 12, wherein said commercializing includes selling references and data from said database.

15. The method of claim 11, further comprising storing said information on talents on talent cards stored in a database, and further comprising selling access to data from said database on payment of a fee.

16. The method of claim 11, further comprising:
creating talent profiles of said talented individuals; and
examining a profile of at least one of said talented individuals and providing an evaluator score;
wherein the evaluator score is derived from at least:
knowledge of an evaluator in a field of the talented individual;
review of a talented individuals talent profile and/or work samples provided by the database; and
a questionnaire.

17. The method of claim 11, further comprising computing an evaluator score by combining multiple individual evaluator scores;
wherein at least one of said evaluated scores in is supplied by an evaluator who is a talented individual in a field being evaluated;
wherein the evaluator has talent card in the database;
and further comprising encouraging the evaluator to evaluate said talented individual in exchange for one or more benefits.

18. The method of claim 11, further comprising commercializing a talent card in part; wherein said commercializing includes an investor providing at least one of employment, sponsorships and donations to a talented person based on their talent card; and further comprising storing information on an investor in the database.

19. The method of claim 18, further comprising ranking the investor in the database based on at least one of a number of talent cards purchased, the employment, sponsorships and/or donations the investor provides to one or more talented individuals.

20. The method of claim 11, further comprising valuing a talent card according to at least one of:
a talent profile of the talented individual;
a score provided by the evaluator; and
a rank of the investor.
